(19) United States
(12) Patent Application Publication
(10) Pub. No.: US 2020/0104635 A1
(43) Pub. Date: Apr. 2, 2020

(54) INVERTIBLE TEXT EMBEDDING FOR LEXICON-FREE OFFLINE HANDWRITING RECOGNITION

(71) Applicant: KONICA MINOLTA LABORATORY U.S.A., INC., San Mateo, CA (US)

(72) Inventor: Ting XU, Campbell, CA (US)

(73) Assignee: KONICA MINOLTA LABORATORY U.S.A., INC., San Mateo, CA (US)

(21) Appl. No.: 16/146,898

(22) Filed: Sep. 28, 2018

(51) Int. Cl. G06K 9/62; G06K 9/00; G06N 3/08

(52) U.S. Cl. CPC G06K 9/6248; G06K 9/6256; G06N 3/08; G06K 9/00154; G06K 9/6276

(57) ABSTRACT

A handwriting recognition method which uses an invertible label embedding (encoding) algorithm to embed character strings into an Euclidean vector space as attribute vectors, uses a CNN to learn and predict attribute vectors of handwriting images in this Euclidean vector space, and then directly decodes a predicted attribute vector into a character string using a decoding algorithm that is the inverse of the invertible encoding algorithm. No lexicon is required to decode the predicted attribute vector. Thus, this method can recognize images containing handwritten digital sequences commonly encountered in many practical applications, such as quantities, dollar, date, phone number, social security numbers, zip code, etc. which are outside of common lexicons.

### BACKGROUND OF THE INVENTION

### Field of the Invention

This invention relates to a handwriting recognition method, and in particular, it relates to handwriting recognition method that employs an invertible text embedding method to embed character strings into an attribute vector space.

### Description of Related Art

Recognizing handwritten characters from scanned images (also known as offline handwriting recognition, or transcription) has remained a challenging task, as demonstrated by the competitions on Handwriting Text Recognition in recent International Conference on Document Analysis and Recognition. Convolutional Neural Network (CNN) based method achieves state-of-the-art recognition accuracy across several commonly used handwriting recognition benchmarks, which are previously dominated by Recurrent Neural Network (RNN) based methods. Handwritten text images are difficult to segment reliably into individual character images especially when the handwriting is cursive and/or when the image quality is not good. Thus, first segmentation then recognition is not a viable approach even if recognizing single characters is considered a solved problem in current machine learning community. Instead of character segmentation, most current approaches segment texts into words and recognize the words directly, because of the presence of space between words in most Latin-based languages makes the word segmentation a more amenable task.

Note that in this disclosure, the term “word” and “line” are used interchangeably, where a “word” can include multiple words or a line in the traditional sense. More specifically, the term “word” means a finite-length sequence of characters drawn from a fixed alphabet E, for example, the set of lowercase letters a-z, digits 0-9, etc.

In one approach, as schematically illustrated in FIG. 1, given an image of a handwritten word, a CNN is employed to estimate a lexical attribute vector v of the word image. A lexical attribute vector typically encodes the presence or number of occurrences of a particular (sub)string in a certain part of word. v is the result of projecting (a process called “image embedding”) the image pixel data into an Euclidean vector space V. Each word in a predefined lexicon E is also projected into the Euclidean vector space V through “label embedding”, which is a deterministic process of mapping strings to lexical attribute vectors. Image embedding is learnt in a supervised manner using a CNN. Transcribing an image is done by finding a word in the lexicon E that has the most similar lexical attribute vector to the lexical attribute vector of the image as predicted by the CNN (as schematically indicated by the dashed line oval in FIG. 1).

The distance between attribute vectors in V reflects lexical similarity, not semantic similarity: “big” and “bag” are close in V but “big” and “huge” are not.

Such an approach is described in Rodriguez-Serrano, J. A., Perronnin, F. and Meylan, F., 2013, Label embedding for text recognition, in Proceedings of the British Machine Vision Conference (“Rodriguez-Serrano et al. 2013”). This paper describes: “The standard approach to recognizing text in images consists in first classifying local image regions into candidate characters and then combining them with high-level word models such as conditional random fields (CRF). This paper explores a new paradigm that departs from this bottom-up view. We propose to embed word labels and word images into a common Euclidean space. Given a word image to be recognized, the text recognition problem is cast as one of retrieval: find the closest word label in this space. This common space is learned using the Structured SVM (SSVM) framework by enforcing matching label-image pairs to be closer than non-matching pairs.” (Id., Abstract.) “In our approach, every label from a lexicon is embedded to an Euclidean vector space. We refer to this step as label embedding. Each vector of image features is then projected to this space. To that end, we formulate the problem in a structured support vector machine (SSVM) framework and learn the linear projection that optimizes a proximity criterion between word images and their corresponding labels. In this space, the “compatibility” between a word image and a label is measured simply as the dot product between their representations. Therefore, given a new word image, recognition amounts to finding the closest label in the common space (FIG. 1 (left)).” (Id., p. 2.)

The label embedding method described in this paper is dubbed Spatial Pyramid of Characters (SPOC), an example of which is shown in FIG. 1 of the paper. The SPOC method recursively divides the string into two even regions at each level. Each character is deemed to occupy one unit of space, and the division can divide the space of a character so that the character can fall into two different regions. For each region at each level, a so-called bag-of-characters (BOC) histogram is computed, which represent the frequencies of the characters in that region. All the BOC histograms are then concatenated. (Id., p. 5, first two paragraphs, and FIG. 1 (right)).

The text embedding approach is also described in Almazán, J., Gordo, A., Fornés, A. and Valveny, E., 2014, Word spotting and recognition with embedded attributes, IEEE transactions on pattern analysis and machine intelligence, 36(12), pp. 2552-2566 (“Almazan et al. 2014”). This paper describes “an approach in which both word images and text strings are embedded in a common vectorial subspace. This is achieved by a combination of label embedding and attributes learning, and a common subspace regression. In this subspace, images and strings that represent the same word are close together, allowing one to cast recognition and retrieval tasks as a nearest neighbor problem.” (Id., Abstract.) With reference to its FIG. 1, the paper describes: “Images are first projected into an attributes space with the embedding function Φ_{I} after being encoded into a base feature representation with f. At the same time, labels strings such as “hotel” are embedded into a label space of the same dimensionality using the embedding function Φ_{y}. These two spaces, although similar, are not strictly comparable. Therefore, we project the embedded labels and attributes in a learned common subspace by minimizing a dissimilarity function F . . . . In this common subspace representations are comparable and labels and images that are relevant to each other are brought together.” (Id., p. 2553, FIG. 1 legend.)

This paper further describes: “In this work we propose to address the [word] spotting and recognition tasks by learning a common representation for word images and text strings. Using this representation, spotting and recognition become simple nearest neighbor problems. We first propose a label embedding approach for text labels inspired by the bag of characters string kernels used for example in the machine learning and biocomputing communities. The proposed approach embeds text strings into a d-dimensional binary space. In a nutshell, this embedding—which we dubbed pyramidal histogram of characters or PHOC—encodes if a particular character appears in a particular spatial region of the string (cf. FIG. 2). Then, this embedding is used as a source of character attributes: we will project word images into another d-dimensional space, more discriminative, where each dimension encodes how likely that word image contains a particular character in a particular region, in obvious parallelism with the PHOC descriptor. By learning character attributes independently, training data is better used (since the same training words are used to train several attributes) and out of vocabulary (OOV) spotting and recognition (i.e., spotting and recognition at test time of words never observed during training) is straightforward. However, due to some differences (PHOCs are binary, while the attribute scores are not), direct comparison is not optimal and some calibration is needed. We finally propose to learn a low-dimensional common subspace with an associated metric between the PHOC embedding and the attributes embedding.” (Id., p. 2553.)

The PHOC text embedding method, an example of which is shown in FIG. 2 of this paper, splits a word into parts at multiple levels, for example: level 2 splits the word into 2 parts, level 3 splits the word in 3 parts, level 4 in 4, etc., and generates a histogram of character for each part of each level. The final PHOC histogram is the concatenation of these partial histograms. (Id., FIG. 2, and p. 2556, Sec. 3.1, first two paragraphs.)

Another paper, Poznanski, A. and Wolf, L., 2016, CNN-N-gram for handwriting word recognition, in Proceedings of the IEEE Conference on Computer Vision and Pattern Recognition (pp. 2305-2314) (“Poznanski et al. 2016”) describes a handwriting word recognition method that uses an attributes based encoding similar to PHOC. “Given an image of a handwritten word, a CNN is employed to estimate its n-gram frequency profile, which is the set of n-grams contained in the word. Frequencies for unigrams, bigrams and trigrams are estimated for the entire word and for parts of it. Canonical Correlation Analysis is then used to match the estimated profile to the true profiles of all words in a large dictionary.” (Id., Abstract.) To encode word images, the method uses “an attributes based encoding, in which the input image is described as having or lacking a set of n-grams in some spatial sections of the word.” (Id., p. 2305.)

In the above approaches, the benefit of using “attributes” is that they are easier to learn by an artificial neural network model. For example, in a training set, a word “abstraction” may appear only 3 times, but the attribute “does TION appears in the second half of the word” may appear many more times. The reason is that many attributes are shared by words thus not every word needs to appear in the training set. This is very important for unconstrained recognition, where out-of-vocabulary words can appear. However, even though CNN predicted attributes can achieve over 90% word accuracy in IAM and RIMES benchmark (see Poznanski et al. 2016), a predefined lexicon (i.e. a dictionary that prescribes all possible words that need to be recognized) imposes a severe limitation when the lexicon is unavailable or prohibitively large, for example, all possible numerical values in a financial form or all possible telephone numbers in a country, etc. In fact, all current designs of lexical attribute vectors and their label embedding processes require predefined lexicons (see Almazán et al. 2014, Rodriguez-Serrano et al. 2013, and Wilkinson T. and Brun A., Semantic and verbatim word spotting using deep neural networks, in Frontiers in Handwriting Recognition (ICFHR), 2016, 15th International Conference on 2016 Oct. 23 (pp. 307-312), IEEE).

Some other known handwriting recognition methods use lexicon-free approaches. One example is Soldevila, A., Almazán, J., 2018, March. Lexicon-free, matching-based word-image recognition, U.S. Pat. No. 9,928,436, which describes: “Methods and systems recognize alphanumeric characters in an image by computing individual representations of every character of an alphabet at every character position within a certain word transcription length. These methods and systems embed the individual representations of each alphabet character in a common vectorial subspace (using a matrix) and embed a received image of an alphanumeric word into the common vectorial subspace (using the matrix). Such methods and systems compute the utility value of the embedded alphabet characters at every one of the character positions with respect to the embedded alphanumeric character image; and compute the best transcription alphabet character of every one of the image characters based on the utility value of each embedded alphabet character at each character position. Such methods and systems then assign the best transcription alphabet character for each of the character positions to produce a recognized alphanumeric word within the received image.” (Abstract.)

Another example is Sfikas, G., Retsinas, G. and Gatos, B., 2017, November, A PHOC Decoder for Lexicon-free Handwritten Word Recognition, in Document Analysis and Recognition (ICDAR), 2017 14th IAPR International Conference on (Vol. 1, pp. 513-518), IEEE, which describes “a novel probabilistic model for lexicon-free handwriting recognition. Model inputs are word images encoded as Pyramidal Histogram Of Character (PHOC) vectors. PHOC vectors have been used as efficient attribute-based, multi-resolution representations of either text strings or word image contents. The proposed model formulates PHOC decoding as the problem of finding the most probable sequence of characters corresponding to the given PHOC. We model PHOC layers as Beta-distributed observations, linked to hidden states that correspond to character estimates. Characters are in turn linked to one another along a Markov chain, encoding language model information. The sequence of characters is estimated using the max-sum algorithm in a process that is akin to Viterbi decoding.” (Abstract.)

### SUMMARY

Embodiments of the present invention provide a handwriting recognition method using an invertible text embedding method to embed character strings into an Euclidean vector space, which does not require a predefined lexicon. Thus, this method can recognize images containing handwritten digital sequences commonly encountered in many practical applications, such as quantities, dollar, date, phone number, social security numbers, zip code, etc. which are outside of common lexicons.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve the above objects, the present invention provides a method implemented in one or mote computer systems for recognizing images of handwritten text, which includes: training an artificial neural network to perform a task of embedding images of handwritten character strings as attribute vectors into an Euclidean vector space, including: providing an untrained artificial neural network; providing training data, the training data comprising a plurality of training images each containing an image of a handwritten character string, and a plurality of training labels, each training label being associated with a training image and identifying a character string represented by the associated training image; and performing a plurality of training iterations on the artificial neural network, wherein each training iteration includes inputting a training image into the artificial neural network to calculate a first attribute vector in the Euclidean vector space, encoding the character string identified by the associated training label into a second attribute vector in the Euclidean vector space using an encoding algorithm, and updating weights of the artificial neural network to minimize a loss function which measures a distance between the first attribute vector and the second attribute vector in the Euclidean vector space, wherein the encoding algorithm uniquely encodes arbitrary character strings into attribute vectors of the Euclidean vector space where no two different character strings are encoded to a same attribute vector in the Euclidean vector space, whereby a trained artificial neural network is obtained after the plurality of training iterations; inputting a target image containing an image of a handwritten character string to the trained artificial neural network to calculate a third attribute vector in the Euclidean vector space; and decoding the third attribute vector using a decoding algorithm to obtain a decoded character string, without performing a nearest neighbor search in the Euclidean vector space.

In some embodiments, the encoding algorithm for encoding an input character string into an encoded attribute vector in the Euclidean vector space includes: recursively bisecting the input character string for a predetermined number of levels to form a binary tree, a root of the binary tree being the input character string, wherein a character string at each non-leaf node of the binary tree is bisected into a left child character string at its left child node and a right child character string at its right child node, the left child character string and the right child character string having equal lengths, a middle character of the character string being omitted in the bisecting, wherein the middle character is a non-empty character when the character string being bisected has an odd number of characters and is an empty character when the character string being bisected has an odd number of characters; for each node of the binary tree, computing a histogram of characters of the corresponding character string, the histogram of characters being a histogram having n values, where n is a size of a defined alphabet, each value being a number of times a corresponding character occurs in the character string; and concatenating all histogram of characters of all nodes of the binary tree according to a predefined order to form the encoded attribute vector, the predefined order being a predefined tree traversal order of traversing the binary tree.

In some embodiments, the decoding algorithm for decoding an attribute vector in the Euclidean vector space into a decoded character string includes: dividing the attribute vector according to the predefined order in which the histograms are concatenated in the encoding algorithm, to obtain individual histograms of characters which form a decoding binary tree, the decoding binary tree having an identical structure as the binary tree formed by the encoding algorithm, each histogram of characters being a node of the decoding binary tree; for each leaf node of the decoding binary tree, decoding the histogram of characters of the leaf node to obtain a corresponding decoded character for the leaf node, wherein the decoded character is a character corresponding to a maximum value of the histogram of characters when the maximum value is greater than a predetermined threshold of confidence value, and is an empty character when the maximum value of the histogram of characters is less than or equal to the predetermined threshold of confidence value; for each non-leaf node of the decoding binary tree, subtracting the histogram of characters of its left child node and the histogram of characters of its right child node from the histogram of characters of the non-leaf node to obtain a difference histogram, and decoding the difference histogram to obtain a corresponding decoded character for the non-leaf node, wherein the decoded character is a character corresponding to a maximum value of the difference histogram when the maximum value is greater than the predetermined threshold of confidence value, and is an empty character when the maximum value of the difference histogram less than or equal to the predetermined threshold of confidence value; and concatenating the decoded characters of all nodes of the decoding binary tree in an order that is a reverse order of the recursive bisecting in the encoding algorithm to form the decoded character string.

In another aspect, the present invention provides a method implemented in a computer system for training an artificial neural network to perform a task of embedding images of handwritten character strings as attribute vectors into an Euclidean vector space, which includes: providing an untrained artificial neural network; providing training data, the training data comprising a plurality of training images each containing an image of a handwritten character string, and a plurality of training labels, each training label being associated with a training image and identifying a character string represented by the associated training image; and performing a plurality of training iterations on the artificial neural network, wherein each training iteration includes inputting a training image into the artificial neural network to calculate a first attribute vector in the Euclidean vector space, encoding the character string identified by the associated training label into a second attribute vector in the Euclidean vector space using an encoding algorithm, and updating weights of the artificial neural network to minimize a loss function which measures a distance between the first attribute vector and the second attribute vector in the Euclidean vector space, wherein the encoding algorithm uniquely encodes arbitrary character strings into attribute vectors of the Euclidean vector space where no two different character strings are encoded to a same attribute vector in the Euclidean vector space, whereby a trained artificial neural network is obtained after the plurality of training iterations.

In another aspect, the present invention provides a method implemented in one or mote computer systems for recognizing images of handwritten text, including: providing a trained artificial neural network; inputting a target image containing an image of a handwritten character string to the trained artificial neural network to calculate an attribute vector in an Euclidean vector space; and decoding the attribute vector using a decoding algorithm to obtain a decoded character string, without performing a nearest neighbor search in the Euclidean vector space.

In another aspect, the present invention provides a computer program product comprising a computer usable non-transitory medium (e.g. memory or storage device) having a computer readable program code embedded therein for controlling a data processing apparatus, the computer readable program code configured to cause the data processing apparatus to execute the above method.

It is to be understood that both the foregoing general description and the following detailed description are exemplary and explanatory and are intended to provide further explanation of the invention as claimed.

### BRIEF DESCRIPTION OF THE DRAWINGS

FIG. 1 schematically illustrates a known handwriting text recognition method that embeds word images and words in a lexicon into a common Euclidean attribute vector space and uses a nearest neighbor search to find the corresponding word for a word image.

FIGS. 2 and 3 schematically illustrate a handwriting text recognition method according to an embodiment of the present invention, which uses an invertible coding method to embed character strings (text labels) into an Euclidean attribute vector space and to directly decode predicted attribute vectors into character strings.

FIG. 4 schematically illustrates the neural network training process according to the embodiment.

FIG. 5 schematically illustrates the word recognition process according to the embodiment.

FIGS. 6A-6D are examples that illustrate an invertible text embedding (encoding) and decoding method according to an embodiment of the present invention.

FIG. 7 illustrates an encoding method for encoding a character string into an attribute vector according to an embodiment of the present invention.

FIG. 8 illustrates a decoding method for decoding an attribute vector into a character string according to an embodiment of the present invention.

FIG. 9 illustrates an exemplary algorithm for decoding an attribute vector according to an embodiment of the present invention.

### DETAILED DESCRIPTION OF PREFERRED EMBODIMENTS

Embodiments of the present invention provide a handwriting recognition method which uses an invertible label embedding (encoding) algorithm to embed character strings into an Euclidean vector space as attribute vectors, uses a CNN to learn and predict attribute vectors of handwriting images in this Euclidean vector space, and then directly decodes a predicted attribute vector into a character string using a decoding algorithm that is the inverse of the invertible encoding algorithm, without requiring a lexicon. As used in the relevant art, a lexicon is a collection of all possible words that can be recognized by a recognition method.

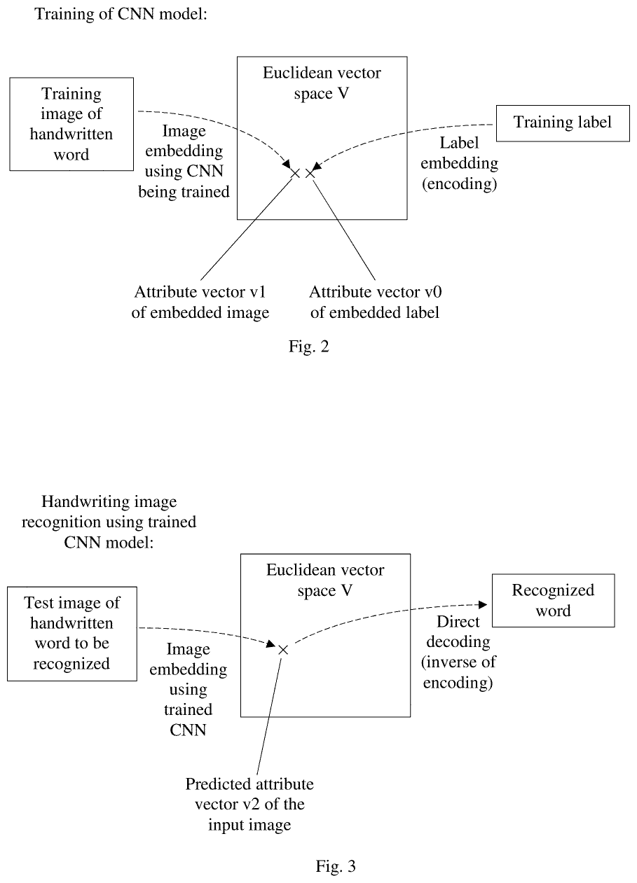

The overall process of the handwriting recognition method according to an embodiment of the present invention is described below with reference to FIGS. 2 and 3, including neural network training (FIG. 2) and prediction and decoding (FIG. 3).

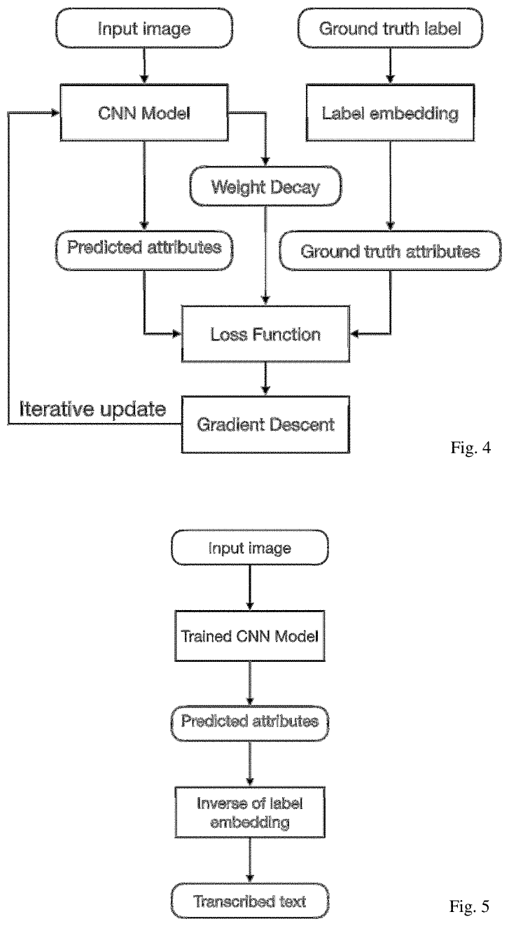

As shown in FIG. 2, an artificial neural network, such as a convolutional neural network (CNN), is trained to perform image embedding to embed images of handwritten words into an Euclidean vector space V. To train a neural network, a large amount of training data is inputted into an untrained network, and an iterative training process is conducted to obtain the weights of the network. Here, the training data are formed of training images of handwritten words along with the associated labels, which are the words the images represent. The words are not limited to any lexicon and can be any finite-length string of characters drawn from a fixed alphabet. During training, in each iteration, a training image is inputted into the neural network to calculate a first attribute vector v1 in the Euclidean vector space V (“image embedding”), and the training label (the word) is embedded into the same Euclidean vector space V using the invertible encoding algorithm (described in detail later) as a second attribute vector v0 (“label embedding (encoding)”). The weights of the neural network are updated to minimize a loss function which measures the distance between the attribute vectors v1 and v0 in the Euclidean vector space. Thus, during training, the label embedding step is used to construct the ground truth of training samples: the ground truth word label is encoded into its corresponding attribute vector as ground truth. The trained neural network is able to predict an attribute vector from an input word image. This neural network training process is summarized in FIG. 4.

In one particular embodiment, an L_2 loss function and stochastic gradient descent are used to train a VGG-based CNN. The VGG model is described in K. Simonyan et al., Very Deep Convolutional Networks For Large-Scale Image Recognition, ICLR 2015. In this embodiment, the CNN also includes a horizontal Spatial Pyramid Pooling before the fully-connected layers to enable arbitrary input image size in the horizontal direction. This is helpful because a CNN would otherwise require input images to have the same size, while the length of the word image may vary greatly as compared to its height.

To recognize a target handwriting image (FIG. 3), the target image is inputted into the trained neural network to predict an attribute vector v2 in the Euclidean vector space V (“image embedding”). A decoding process is then applied to the predicted attribute vector v2, using a decoding algorithm which is the inverse of the encoding (label embedding) algorithm used in the training process. The result of the decoding process is the recognition result, i.e. the character string that is recognized. This image recognition process is summarized in FIG. 5.

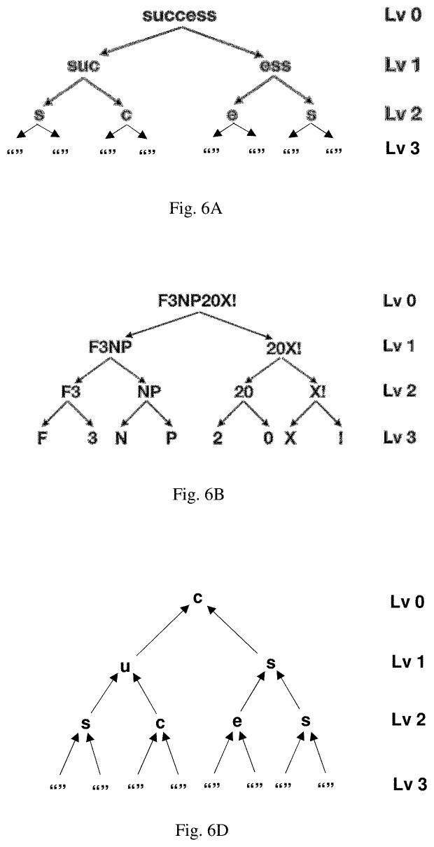

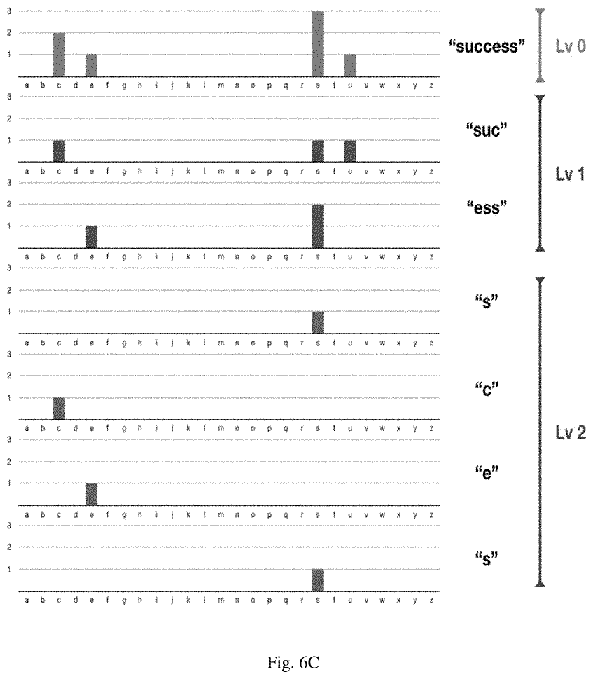

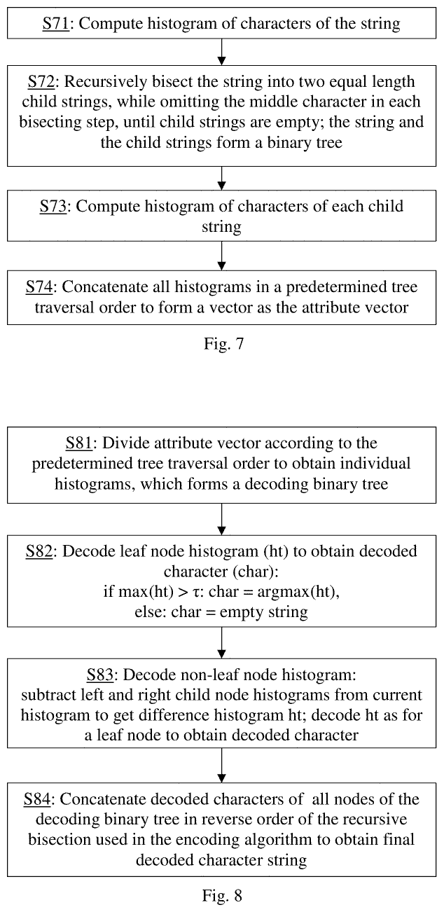

The invertible encoding (label embedding) and decoding algorithms used in the above embodiment, referred to as “invertible Pyramidal Histogram of Characters” (iPHOC), are described below with reference to FIGS. 7 and 8 and using the examples shown in FIGS. 6A-6D.

It is assumed that all characters of the string being encoded belong to a known and fixed alphabet Σ. The encoding of a character string into an iPHOC attribute vector uses a recursive bisection and histogram computation process. A predetermined parameter k represents the maximum number of levels of bisection, which also defines the maximum length of the character string that can be encoded. More specifically, given an arbitrary character string, its iPHOC attribute vector is constructed by computing the histogram of characters of the string itself (step S71), then recursively bisecting the string into two equal length child strings (step S72) and computing the histogram of characters of each child string (step S73), until the child strings become empty (and thereafter, the child strings of the remining ones of the k levels are all empty strings). In each bisecting step, if the string being bisected has an odd number of characters, its middle character is omitted in the next level child strings. Thus, the child strings at each level always have the same number of characters. If the string being bisected has an even number of characters, it is deemed to have an omitted middle character that is an empty character.

For example, in FIG. 6A, “success” (level 0) is bisected into two child strings “suc” and “ess” (omitting the middle character “c”) (level 1), which are further bisected into smaller child strings “s” and “c”, and “e” and “s” (again omitting the respective middle characters) (level 2). The next level bisections (level 3) are all empty, as indicated by the quotation marks. FIG. 6B shows the bisection of a string that is not a common word.

This bisecting process can be represented as a binary tree, where the root of the tree is the original string and the other nodes are the child strings. This binary tree can also be seen as a coarse-to-fine pyramid where each level focuses on smaller and smaller child strings.

For each node of the binary tree, a histogram of characters is calculated from the character string of that node (step S73), which is a histogram with n values (n being the size of the alphabet Σ), each value being the number of times the corresponding character occurs in the string. FIG. 6C shows the histograms of levels 0 to 2 for the example of FIG. 6A (in this example, all child strings at level 3 are empty, so all level 3 histograms have zero values and are not shown in FIG. 6C).

Note that the omission of the middle character when bisecting odd-length strings does not cause any lost of information. During decoding, the omitted middle characters can always be recovered by finding the difference between a histogram of a node and the sum of the two histograms of its left and right child node (and if there is no difference, then the omitted middle character is empty). For example, the central “c” in “success” can be found by subtracting the sum of two level 1 histograms (for “suc” and “ess”) from the level 0 histogram (for “success”) (see FIG. 6C).

After the bisection is completed, all histograms for all nodes of the tree (including the zero histograms) are concatenated in an order defined by a predetermined tree traversal of the binary tree, to form a vector as the attribute vector (step S74). A tree traversal is an order of visiting each node of a tree exactly once (described in more detail later).

For an iPHOC encoding of k levels, there will be (2^{k}−1) histograms; and with an alphabet of size n, the attribute vector's dimension will be (2^{k}−1)*n. Since the middle characters are omitted when bisecting odd-length strings, the maximum length of strings that the iPHOC coding with k levels can represent is 2^{k}−1. For most application of transcribing word images, k=4 (levels 0 to 3) is sufficient, which gives a maximum transcription length of 15 characters. Note here that the k levels include level 0 (root level) which corresponds to the original string.

To decode a CNN-predicted iPHOC attribute vector of dimension (2^{k}−1)*n, the vector is divided to obtain (2^{k}−1) individual histograms each of size n, using the same order in which the histograms are concatenated in the encoding algorithm, i.e., the same predetermined tree traversal order (step S81). These individual histograms can be placed on a binary tree (referred to as the decoding binary tree for convenience) having the same structure as the binary tree used in the encoding algorithm (referred to as the encoding binary tree for convenience).

For each leaf node of the decoding binary tree, the histogram is decoded to obtain a decoded character in the follow way (step S82): If the maximum histogram value is greater than a predetermined threshold of confidence τ (0<τ<1), the decoded character is the character having the maximum histogram value; if the maximum histogram value is less than or equal to the threshold of confidence τ, the decoded character is an empty or null character. Here, the real values of the histogram are used directly to perform decoding. The decoded character for each leaf node, which contains either a single character or no character, corresponds to the character represented by the leaf node of the encoding binary tree.

For each non-leaf node of the decoding binary tree, the histograms of its left and right child nodes are subtracted from the histogram of the current node to obtain a difference histogram (step S83). The difference histogram is decoded to obtain a decoded character in the same way as for a leaf node histogram (step S83), i.e.: If the maximum histogram value is greater than the threshold of confidence τ, the decoded character is the character having the maximum histogram value; if the maximum histogram value is less than or equal to the threshold of confidence τ, the decoded character is an empty or null character. The decoded character for each non-leaf node, which contains either a single character or no character, corresponds to the omitted middle character when bisecting that node in the encoding algorithm. As noted earlier, the omitted middle character is either a non-empty character (when the string being bisected has an odd number of characters) or an empty character (when the string being bisected has an even number of characters).

Note that the processing steps for the leaf nodes and the non-leaf nodes may be done in any order because the steps are not dependent on each other.

As a result, a decoded character (which may be an empty character) is generated for each node of the decoding binary tree. FIG. 6D illustrates the decoded characters organized in the decoding binary tree, corresponding to the example of FIG. 6A.

The decoded characters for all the nodes of the decoding binary tree are concatenated together, based on an order that is the reverse of the recursive bisection used in the encoding algorithm, to obtain a character string that is the final decoding result (step S84).

For example, starting from the leaf nodes and working progressively toward the root node, the character strings for a pair of left and right child nodes and their parent node are concatenated in the order of “left child node, parent node, right child node” to form the concatenated character string of the parent node. The concatenation progresses toward the root node, each time using already concatenated character strings for the left and right child nodes and the decoded character of the parent node. The concatenated character string for the root node is the final decoding result. For example, for the example of FIG. 6D, the concatenated character string for the left most node at level 2 is “ ” “s” “ ”, i.e. “s”; the concatenated character string for the left most node at level 1 is “s” “u” “c”, i.e. “suc”; etc.

The concatenation of the decoded characters may also be done by traversing the binary tree using an in-order tree traversal and concatenating the decoded characters of the nodes in that order. In-order tree traversal gives the original string in this case because of the way the string is recursively bisected in the encoding algorithm.

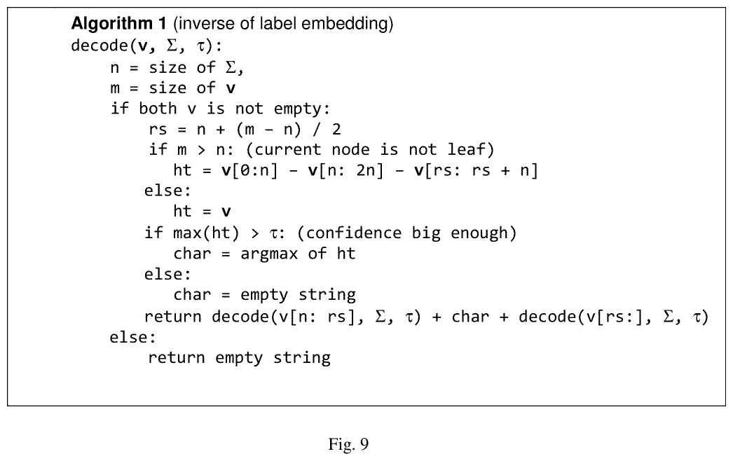

The actual implementation of the decoding algorithm may perform the step of dividing the attribute vector into individual histograms (step S81), the steps of decoding each histogram to obtain the corresponding decoded character (steps S82 and S83), and the steps of concatenating the decoded characters (step S84) in any suitable order. For example, a recursive algorithm may be used which may go in either a root to leaf direction or a leaf to root direction, performing the dividing, decoding and concatenating steps concurrently. As a particular example, in the program code for a decoding algorithm set forth in FIG. 9, decoding progresses from root to leaf, and one histogram (ht) is extracted from the attribute vector (v) at a time and decoded into a decoded character (char), and the steps are performed recursively while concatenating the decoded character with the next level decoding result.

As mentioned above, the encoding and decoding processes use the same binary tree traversal order when concatenating the multiple histograms of the tree into the attribute vector and when dividing the attribute vector into the multiple histograms of the tree. A tree traversal (also referred to as tree search) is an order of visiting each node of a tree exactly once. Many tree traversal methods are known, including, for example, depth-first search and breath-first search. Depth-first search includes pre-order, in-order, and post-order search. These tree traversal methods are well known in the computer art (see, for example, the Wikipedia article entitled Tree traversal), and are not described in detail here. In a preferred embodiment, a pre-order traversal is used to traverse the tree in the encoding and decoding processes. For example, in the example of FIG. 6B, using pre-order traversal, the order of the nodes will be: F3NP20X!--F3NP--F3--F--3--NP--N--P--20X!--20--2--0--X!--X--!. The decoding program code set forth in FIG. 9 uses a pre-order tree traversal. Other tree traversal orders may be used as well.

As can be seen, the invertible label encoding and decoding method is a one-to-one mapping between character strings and a set of grid points of the Euclidean vector space. “Grid points” are points (i.e. vectors) in the Euclidean vector space for which the values of the coordinates (i.e. values of the elements of the vector) are natural numbers. Each character string (arbitrary string, not required to belong to a lexicon) can be uniquely encoded by the encoding method to a grid point of the Euclidean vector space. Each valid grid point can be uniquely decoded by the decoding method to a character string, without requiring the string to belong to a lexicon. Note here that only a subset of grid points in the vector space are “valid” grid points that represent “valid” attribute vectors. For example, for an alphabet of size 2 (n=2) and 2 bisection levels (k=2), the dimension of the vector space is 6. Let v=[v1, v2, v3, v4, v5, v6] be a grid point in this space, v must satisfy v1+v2>=v3+v4+v5+v6 to be a valid grid point, since the number of characters in higher level child strings is less than those of lower levels. Any vector predicted by the CNN is effectively rounded to its nearest grid point and decoded to the corresponding character string, regardless of whether the character string belongs to a lexicon. In actual implementation, because real-valued vectors cannot be directly converted to text, and direct rounding can affect accuracy, a deterministic algorithm as that described above is used to decode these vectors to character strings, using a preset threshold τ, which can be interpreted as a confidence threshold to transcribe a particular character. This way, a fixed lexicon is not required for decoding. This method is simple and fast, as it does not require an optimization (nearest neighbor search) process for decoding.

To the contrary, the SPOC and PHOC coding methods in Rodriguez-Serrano et al. 2013 and Almazán et al. 2014 do not provide an invertible decoding method. In these coding methods, each words of the lexicon is mapped to a grid point, but not uniquely. For SPOC, strings containing the same characters are map to the same attribute vectors even though they have different length. For example, let the alphabet be {a, b, c} and k=2, level 1 of SPOC(“aaa”) are the same as level 1 of SPOC(“aa”), and level 2 of that of two string are the same also: [1, 0, 0, 1, 0, 0] (refer to the second to last paragraph in section 2.3 of their paper). So given a vector of [1, 0, 0, 1, 0, 0, 1, 0, 0], one would not be able to tell whether it represents “aaa” or “aa”. For PHOC, histogram only record occurrence. Unlike iPHOC and SPOC, PHOC divide texts into {1, 2, 3, . . . } regions instead of bisection only. If the number of levels are {1, 2, 3}, level 1 of PHOC(“abc”) and PHOC(“abbc”) are both [1, 1, 1], and level 2 of that of two strings are both [1, 1, 0, 0, 1, 1] and level 3 are both [1, 0, 0, 0, 1, 0, 0, 0, 1] (refer to the last paragraph in section 3.1 of their paper), again indistinguishable between “abbc” and “abc”. These characteristics of SPOC and PHOC are not likely to cause problems in actual application because the coding methods are only intended to be used for recognizing character strings that belong to a practical lexicon, where the lexicon is unlikely to contain strings or substrings like those examples discussed above. However, in applications where the character string to be recognized can be any arbitrary strings, these characteristics of SPOC and PHOC will present a problem.

Another difference between the encoding algorithm of the present embodiments and SPOC and PHOC is that SPOC and PHOC do not drop any characters during their division process and each designed their particular letter assignment scheme when calculating the histogram for each resulting region.

Moreover, in SPOC and PHOC, not all grid points correspond to words in the lexicon. Thus, during recognition, given a predicted attribute vector, a nearest neighbor searching step is required to find the nearest point that corresponds to a word in the lexicon.

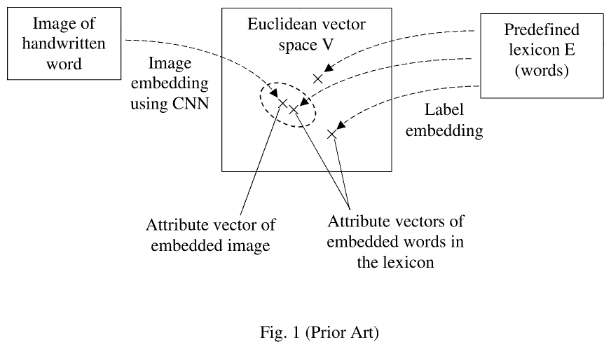

To summarize, the handwriting recognition process according to embodiments of the present invention differs from the SPOC and PHOC coding methods described in the Rodriguez-Serrano et al. 2013 and Almazán et al. 2014 (see also FIG. 1) in that, here, after the target image is embedded into the Euclidean vector space, no nearest neighbor search is done; rather, the predicted attribute vector v2 of the target image is directly subject to the decoding algorithm to obtain the recognition result. This is possible because the label embedding uses an invertible coding scheme which is a one-to-one mapping between valid grid points of the Euclidean vector space and character strings.

Thus, embodiments of the present invention provide a handwriting recognition method enables unconstrained transcription of handwritten word images. “Unconstrained” refers to the fact that the method does not require the use of a predefined lexicon during transcription. The method resolve the technical difficulty of transcribing a textual image that may contain arbitrary text. The method provides a defined procedure to encode and decode text embedding without using optimization or machine learning based methods for encoding and decoding (machine learning is only used to embed the handwriting image into the attribute vector space). This method enables the recognition of textual images that are not contained in a lexicon, such as financial numbers in accounting forms, or any character sequences that is not pre-defined.

Is should be noted that when the image to be processed is a scanned image with textual information, it first needs to be preprocessed to remove noise, correct skewness, and analyze its layout so that textual region can be located. Those textual regions are then segmented into line images and further into word images. In the network training process and image recognition process described above, all input images are word images that have been subject to the above pre-processing.

The handwriting recognition method described above can be implemented on one or more computer systems which include memories storing computer executable programs and processors executing such programs. The one or more computer systems that implement the artificial neural network may include one or more GPU cluster machines. Different parts of the process (e.g., network training, prediction using trained network, etc.) may be implemented on different computers or computer systems.

It will be apparent to those skilled in the art that various modification and variations can be made in the handwriting recognition method of the present invention without departing from the spirit or scope of the invention. Thus, it is intended that the present invention cover modifications and variations that come within the scope of the appended claims and their equivalents.

What is claimed is:

1. A method implemented in one or mote computer systems for recognizing images of handwritten text, comprising:
training an artificial neural network to perform a task of embedding images of handwritten character strings as attribute vectors into an Euclidean vector space, comprising:
providing an untrained artificial neural network;
providing training data, the training data comprising a plurality of training images each containing an image of a handwritten character string, and a plurality of training labels, each training label being associated with a training image and identifying a character string represented by the associated training image; and
performing a plurality of training iterations on the artificial neural network, wherein each training iteration includes inputting a training image into the artificial neural network to calculate a first attribute vector in the Euclidean vector space, encoding the character string identified by the associated training label into a second attribute vector in the Euclidean vector space using an encoding algorithm, and updating weights of the artificial neural network to minimize a loss function which measures a distance between the first attribute vector and the second attribute vector in the Euclidean vector space,
wherein the encoding algorithm uniquely encodes arbitrary character strings into attribute vectors of the Euclidean vector space where no two different character strings are encoded to a same attribute vector in the Euclidean vector space,
whereby a trained artificial neural network is obtained after the plurality of training iterations;
inputting a target image containing an image of a handwritten character string to the trained artificial neural network to calculate a third attribute vector in the Euclidean vector space; and
decoding the third attribute vector using a decoding algorithm to obtain a decoded character string, without performing a nearest neighbor search in the Euclidean vector space.

2. The method of claim 1, wherein the encoding algorithm for encoding an input character string into an encoded attribute vector in the Euclidean vector space includes:
recursively bisecting the input character string for a predetermined number of levels to form a binary tree, a root of the binary tree being the input character string,
wherein a character string at each non-leaf node of the binary tree is bisected into a left child character string at its left child node and a right child character string at its right child node, the left child character string and the right child character string having equal lengths, a middle character of the character string being omitted in the bisecting, wherein the middle character is a non-empty character when the character string being bisected has an odd number of characters and is an empty character when the character string being bisected has an odd number of characters;
for each node of the binary tree, computing a histogram of characters of the corresponding character string, the histogram of characters being a histogram having n values, where n is a size of a defined alphabet, each value being a number of times a corresponding character occurs in the character string; and
concatenating all histogram of characters of all nodes of the binary tree according to a predefined order to form the encoded attribute vector, the predefined order being a predefined tree traversal order of traversing the binary tree.

3. The method of claim 2, wherein the decoding algorithm for decoding an attribute vector in the Euclidean vector space into a decoded character string includes:
dividing the attribute vector according to the predefined order in which the histograms are concatenated in the encoding algorithm, to obtain individual histograms of characters which form a decoding binary tree, the decoding binary tree having an identical structure as the binary tree formed by the encoding algorithm, each histogram of characters being a node of the decoding binary tree;
for each leaf node of the decoding binary tree, decoding the histogram of characters of the leaf node to obtain a corresponding decoded character for the leaf node, wherein the decoded character is a character corresponding to a maximum value of the histogram of characters when the maximum value is greater than a predetermined threshold of confidence value, and is an empty character when the maximum value of the histogram of characters is less than or equal to the predetermined threshold of confidence value;
for each non-leaf node of the decoding binary tree, subtracting the histogram of characters of its left child node and the histogram of characters of its right child node from the histogram of characters of the non-leaf node to obtain a difference histogram, and decoding the difference histogram to obtain a corresponding decoded character for the non-leaf node, wherein the decoded character is a character corresponding to a maximum value of the difference histogram when the maximum value is greater than the predetermined threshold of confidence value, and is an empty character when the maximum value of the difference histogram less than or equal to the predetermined threshold of confidence value; and
concatenating the decoded characters of all nodes of the decoding binary tree in an order that is a reverse order of the recursive bisecting in the encoding algorithm to form the decoded character string.

4. A method implemented in a computer system for training an artificial neural network to perform a task of embedding images of handwritten character strings as attribute vectors into an Euclidean vector space, comprising:
providing an untrained artificial neural network;
providing training data, the training data comprising a plurality of training images each containing an image of a handwritten character string, and a plurality of training labels, each training label being associated with a training image and identifying a character string represented by the associated training image; and
performing a plurality of training iterations on the artificial neural network, wherein each training iteration includes inputting a training image into the artificial neural network to calculate a first attribute vector in the Euclidean vector space, encoding the character string identified by the associated training label into a second attribute vector in the Euclidean vector space using an encoding algorithm, and updating weights of the artificial neural network to minimize a loss function which measures a distance between the first attribute vector and the second attribute vector in the Euclidean vector space,
wherein the encoding algorithm uniquely encodes arbitrary character strings into attribute vectors of the Euclidean vector space where no two different character strings are encoded to a same attribute vector in the Euclidean vector space,
whereby a trained artificial neural network is obtained after the plurality of training iterations.

5. The method of claim 4, wherein the encoding algorithm for encoding an input character string into an encoded attribute vector in the Euclidean vector space includes:
recursively bisecting the input character string for a predetermined number of levels to form a binary tree, a root of the binary tree being the input character string,
wherein a character string at each non-leaf node of the binary tree is bisected into a left child character string at its left child node and a right child character string at its right child node, the left child character string and the right child character string having equal lengths, a middle character of the character string being omitted in the bisecting, wherein the middle character is a non-empty character when the character string being bisected has an odd number of characters and is an empty character when the character string being bisected has an odd number of characters;
for each node of the binary tree, computing a histogram of characters of the corresponding character string, the histogram of characters being a histogram having n values, where n is a size of a defined alphabet, each value being a number of times a corresponding character occurs in the character string; and
concatenating all histogram of characters of all nodes of the binary tree according to a predefined order to form the encoded attribute vector, the predefined order being a predefined tree traversal order of traversing the binary tree.

6. A method implemented in one or mote computer systems for recognizing images of handwritten text, comprising:
providing a trained artificial neural network;
inputting a target image containing an image of a handwritten character string to the trained artificial neural network to calculate an attribute vector in an Euclidean vector space; and
decoding the attribute vector using a decoding algorithm to obtain a decoded character string, without performing a nearest neighbor search in the Euclidean vector space.

7. The method of claim 6, wherein the decoding algorithm includes:
dividing the attribute vector according to a predefined order which is based on a binary tree traversal order, to obtain individual histograms of characters which form a decoding binary tree, each histogram of characters being a node of the decoding binary tree;
for each leaf node of the decoding binary tree, decoding the histogram of characters of the leaf node to obtain a corresponding decoded character for the leaf node, wherein the decoded character is a character corresponding to a maximum value of the histogram of characters when the maximum value is greater than a predetermined threshold of confidence value, and is an empty character when the maximum value of the histogram of characters is less than or equal to the predetermined threshold of confidence value;
for each non-leaf node of the decoding binary tree, subtracting the histogram of characters of its left child node and the histogram of characters of its right child node from the histogram of characters of the non-leaf node to obtain a difference histogram, and decoding the difference histogram to obtain a corresponding decoded character for the non-leaf node, wherein the decoded character is a character corresponding to a maximum value of the difference histogram when the maximum value is greater than the predetermined threshold of confidence value, and is an empty character when the maximum value of the difference histogram less than or equal to the predetermined threshold of confidence value; and
concatenating the decoded characters of all nodes of the decoding binary tree in a predefined order to form the decoded character string.
